(19) United States
(12) Patent Application Publication
(10) Pub. No.: US 2026/0253937 A1
(43) Pub. Date: Aug. 27, 2026

(54) AUTOMATIC MACHINE AND RELATED METHOD FOR THE PRODUCTION OF WINDINGS STARTING FROM A STRIP OF MATERIAL SUITABLE FOR THE MANUFACTURE OF ELECTRICAL ENERGY STORAGE DEVICES

(71) Applicant: MANZ ITALY S.R.L., SASSO MARCONI (BO) (IT)

(72) Inventor: Michele Adriano Di Monte, SASSO MARCONI (BO) (IT)

(73) Assignee: MANZ ITALY S.R.L., SASSO MARCONI (BO) (IT)

(21) Appl. No.: 18/871,260

(22) PCT Filed: Jun. 6, 2023
(86) PCT No.: PCT/IB2023/055794

§ 371 Date: Dec. 3, 2024

(30) Foreign Application Priority Data
Jun. 7, 2022 (IT) 102022000011993

(51) Int. Cl. H01M 10/04

(52) U.S. Cl. CPC H01M 10/0409; H01M 10/0431

(57) ABSTRACT

An automatic machine is described for the production of windings starting from at least one strip made of material suitable for the manufacture of electrical energy storage devices and comprising an applicator apparatus operatively arranged downstream of a winding core and configured to apply an electrically insulating tape to a previously formed winding; wherein the applicator apparatus comprises a retaining member; a feeding device configured to feed the insulating tape towards the winding; and a folding device configured to progressively refold the second longitudinal portion of the insulating tape onto the axial surface of the winding adjacent to said end edge.

### CROSS-REFERENCE TO RELATED APPLICATIONS

This patent application is related to Italian Patent Application No. 102022000011993 filed on Jun. 7, 2022, the entire disclosure of which is incorporated herein by reference.

### TECHNICAL SECTOR

The present invention relates to an automatic machine and a related method for the production of windings starting from a strip of material suitable for the manufacture of electrical energy storage devices, in particular from a plurality of strips of material, e.g. from at least one electrode strip and at least one separator strip. Furthermore, the present invention relates to an electrical energy storage device.

In particular, the present invention finds advantageous but not exclusive application in the production of capacitors or rechargeable batteries, more specifically in the production of cylindrical rechargeable batteries or in any case comprising cylindrical windings, to which the following description will make explicit reference without loss of generality.

### BACKGROUND ART

Automatic machines are known for the production of electrical energy storage devices, and in particular rechargeable batteries or capacitors.

Rechargeable batteries usually comprise two electrode layers (cathode and anode) and at least two separator layers arranged offset from each other in an alternating electrode-separator-electrode-separator pattern.

These layers are obtained from continuous strips of material (electrode or separator) that are cut to predetermined lengths.

In the case of the above-mentioned cylindrical batteries, the automatic machines comprise winding apparatuses which are configured to feed, via respective feeding units, the electrode and separator strips along different feeding paths that all converge towards a rotating winding core.

This winding core is configured to hold and wind, usually around an elongated support (known as a “spindle”), the electrode and separator strips arranged in a staggered pattern, so as to form a winding, usually cylindrical or oval.

In detail, known winding apparatuses involve first feeding only the separator strips to the winding core and then, after the separator strips are gripped by the winding core and have completed at least a couple of winding turns around it, the electrode strips according to the alternating pattern mentioned above.

In this way, before or after being cut to the desired length, the electrode strips are retained and dragged in rotation by the separator strips so as to form a winding.

In more detail, a winding apparatus of an automatic machine of the known type comprises a feeding unit configured to feed two separator strips, along respective feeding paths, to the winding core, in particular initially spaced apart and subsequently converging at the winding core, and configured to feed the two electrode strips, i.e. the cathode and the anode, to the winding core along respective feeding paths.

Generally, the cathode is fed along a feeding path between the feeding paths of the separator strips, while the anode is fed along a feeding path converging with the winding core so as to be superimposed on one of the separator strips, in particular the one radially internal with respect to the winding.

In this way, the cathode strip is fed to the winding core already interposed between the two initially open separator strips, so that the aforementioned alternating electrode-separator-electrode-separator pattern (in detail, anode-separator-cathode-separator) is obtained.

The separator strips are initially wound into respective coils, each of which is rotationally supported by a respective shaft or spindle.

Similarly, the electrode strips are initially wound into respective coils, each of which is rotationally supported by a respective shaft or spindle.

Winding apparatuses of the known type also include respective cutting units configured to cut the respective strips (separator and electrode) once the preset winding length of each strip has been reached, i.e. once the nominal radius of the winding has been reached.

Preferably, the electrode strips are cut by the respective cutting units before the winding is finished, i.e. before the end of the winding process, while at least one further winding turn is made with the separator strips only.

Subsequently, the latter are also cut by the respective cutting unit and the cut flaps are rewound by the winding core to form the last concentric layers of the winding, while the strips are retained by respective gripping units of the winding apparatus.

Once the winding is finished, the winding is closed, for example by a portion of adhesive tape, in what is known as a “taping” operation.

In this regard, the winding core is typically mounted on a rotating platform of the winding apparatus arranged and configured so that at each rotation step of said platform, the winding core is moved between a winding station, where the aforementioned winding operation is performed and the winding is formed, and a closing (or “taping”) station, where the already formed winding is closed by further winding with a portion of adhesive tape at least partially around it (to fasten the hanging flap to the rest of the winding).

In some known configurations, the rotating platform comprises an additional rotation step to move the winding, sequentially, between the winding station, the closing station and an unloading station, where the finished and closed winding is unloaded for its subsequent insertion into a container, usually called a “can”, e.g. cylindrical and metallic.

Typically, the winding apparatus thus comprises three winding cores (and thus three “spindles”), which are carried by the rotating platform and are moved by it, Selectively and sequentially, between the winding station, the closing station and the unloading station.

Each electrode strip of the winding thus obtained must then be electrically connected to a respective terminal, which will define a terminal (positive or negative) of the battery.

In this regard, electrode strips generally include tabs for electrical connection to the respective terminals (positive or negative).

This container, or “can”, usually consists of two elements, which conventionally determine the positive and negative poles of the battery. Generally, the positive pole is defined by an element comprising both the lateral surface of the can and a first between the bases, usually provided by a protuberance, while the negative pole is defined by the second between the two bases of the can.

It is therefore well known in the sector that the part of the cylindrical winding adapted to be in contact with the second base needs to be insulated from the lateral surface of the aforementioned container or “can”, in order to allow the battery to function properly avoiding short circuits, preferably considering possible dynamic conditions to which the storage device may be subject (e.g. in the battery pack of a car, subject to vibrations and possible jolts).

Therefore, in particular, it is necessary to insulate the axial surface of the winding, which, once the winding is inserted into the cylindrical can, will rest on the bottom of the can.

For this purpose, it is well known to apply an insulating material element, e.g. plastic/rubber, to the respective axial surface (i.e. circular), so as to isolate the negative pole of the winding, allowing only the terminal to pass through to be coupled to the second base.

In some cases, the insulating elements are defined by adhesive labels, often made of plastic material.

Thus, known automatic machines include an apparatus for applying such insulating discs arranged downstream of the winding apparatus (in particular downstream of the unloading station), which includes various devices configured respectively to feed the labels, to perform a “peeling” operation whereby each label is deprived of the backing protecting its adhesive side, and to apply the labels to the axial surface of the winding to be insulated.

However, the application of such labels is quite problematic, as the correct handling of them is rather complicated, especially at the high production speeds required by the industry.

In other cases, the insulating elements are defined by discs or disc-shaped caps. In these cases, the application apparatus is even more complex, as it must include a unit for gluing the insulating element and/or a unit for the precise application of the insulating element at the respective axial end of the winding.

In addition, in the case of both labels and discs or caps, the insulating elements must provide an axial slot for the passage of the relevant tab or end tab (e.g. connected to the anode of the storage device), which is then folded over the axial surface covered by the insulating element, to be placed in contact with the relevant terminal (i.e. the second base). This introduces an additional positioning constraint for the correct centring of the insulating element on the surface to be insulated, increasing the complexity of the application apparatus and the risk of errors.

In addition, there is growing interest in the use of “tabless” windings, i.e. whose electrode strips do not have the aforementioned tabs. In this case, a so-called contact disc made of conductive material must be applied at (and covering) one of the axial ends of the winding (e.g. the negative end), which contact disc serves as the connection element to the respective terminal for one of the two electrode strips.

In such a case, it is particularly complex, if not impossible, to securely isolate this contact disc (from the lateral surface of the can) while ensuring the necessary electrical connection.

There is therefore a need to simplify the application of insulating elements to the windings produced by automatic machines of the type described above, while at the same time improving the insulation effectiveness of the winding from the can.

### OBJECT AND SUMMARY OF THE INVENTION

The object of the present invention is to provide an automatic machine, and a related method, for the production of windings from a strip of material adapted for the manufacture of electrical energy storage devices, which are of high reliability and low cost, and which make it possible to overcome at least some of the drawbacks specified above and associated with the above-mentioned machines and production methods of the known type. Furthermore, the purpose of the present invention is to provide an electrical energy storage device.

According to the invention, this purpose is achieved by an accumulation device, an automatic machine and a related method as claimed in the independent claims below, and preferably in any of the claims dependent directly or indirectly on the independent claims.

The claims describe preferred embodiments of the present invention forming an integral part of the present description.

### BRIEF DESCRIPTION OF THE DRAWINGS

For a better understanding of the present invention, some preferred non-limiting embodiments are described below, purely by way of example and with the aid of the attached drawings, in which:

FIG. 1 is a schematic lateral view, with parts removed for clarity's sake, of an automatic machine for the production of windings made according to the present invention;

FIG. 2 is a perspective view, on an enlarged scale and with parts removed for clarity's sake, of a detail of the machine of FIG. 1;

FIGS. 3 and 4 are perspective views, on an enlarged scale and with parts removed for clarity's sake, of components of the apparatus of FIG. 2, during two distinct and successive operating conditions;

FIG. 5 is a top view, on an enlarged scale and with parts removed for clarity's sake, of the components of FIG. 4;

FIGS. 6 and 7 are perspective views, on an enlarged scale and with parts removed for clarity's sake, of components of the apparatus of FIG. 2 according to an alternative embodiment of the present invention and during two distinct and successive operating conditions;

FIG. 8 is a top view, on an enlarged scale and with parts removed for clarity's sake, of the components of FIG. 6;

FIG. 9 is a perspective view, on an enlarged scale and with parts removed for clarity's sake, of components of the apparatus of FIG. 2 according to an alternative embodiment not forming part of the present invention and shown for illustrative purposes only;

FIG. 10 is a perspective view, on an enlarged scale and with parts removed for clarity's sake, of one of the components of FIG. 9; and

FIG. 11 is a top view, on an enlarged scale and with parts removed for clarity's sake, of the components in FIG. 9.

### DETAILED DESCRIPTION

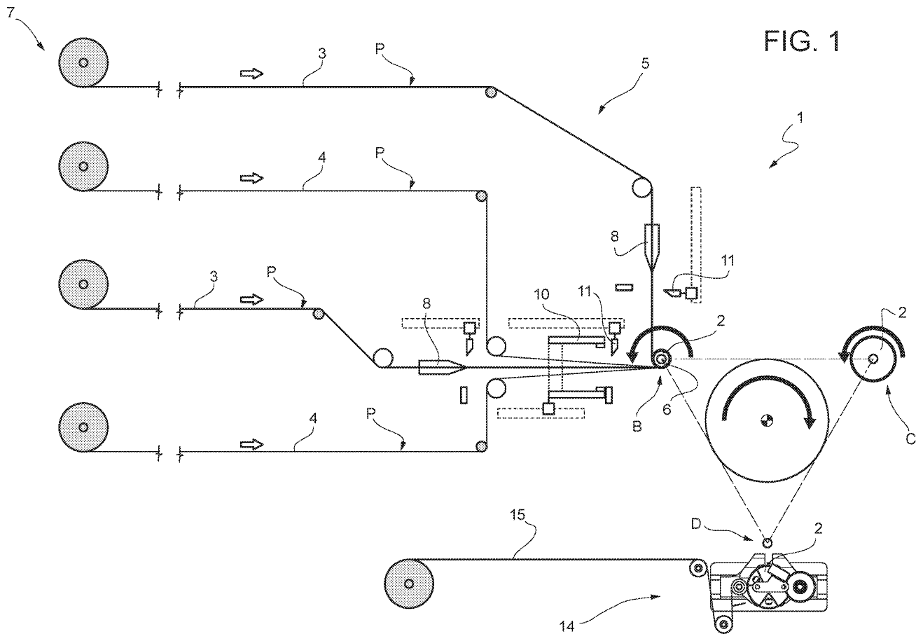

With reference to FIG. 1, an automatic machine for the production of windings 2 starting from at least one strip of material suitable for the manufacture of electrical energy storage devices is referred to as 1.

In particular, the machine 1 is configured to produce windings 2 from electrode strips 3 and separator strips 4 suitable for the manufacture of electrical energy storage devices.

In the case illustrated, the machine 1 is configured to produce windings 2 starting from two electrode strips 3 (one cathode strip and one anode strip) and two Separator strips 4.

More specifically, the machine 1 is configured to produce cylindrical windings 2, the description of which will make explicit reference without loss of generality, or with a flattened shape (e.g. wound onto a flat pin).

In light of the foregoing, the present invention finds advantageous but not exclusive application in the production of capacitors or rechargeable batteries, more specifically in the production of cylindrical or oval rechargeable batteries 2, to which the following description will make explicit reference without loss of generality.

Rechargeable batteries comprise two electrode layers (cathode and anode) and at least two separator layers arranged offset from each other in an alternating electrode-separator-electrode-separator pattern.

These layers are obtained from the aforementioned continuous strips 3, 4, which are cut to predetermined lengths to form a sequence of windings 2.

In this regard, the machine 1 comprises a winding apparatus 5 configured to wind the electrode strips 3 and separator 4 onto themselves to form the aforementioned sequence of windings 2.

These windings 2 are then placed, during a process known downstream of the apparatus 5, inside containers or “cans” (usually metal), which, in the case of conventional batteries, are then filled with an electrolyte to form a respective rechargeable “jelly roll” type battery (in the case of solid-state batteries, the electrolyte is instead integrated into the coil and integral to the separator strips).

Therefore, in this case, the apparatus 5 is used to wind two electrode strips 3, a cathode and an anode, and two separator strips 4 arranged offset from each other according to the aforementioned alternating pattern, so as to form a battery or capacitor, or more specifically a battery module or capacitor unit of a capacitor.

As can be seen in FIG. 1, the apparatus 5 (and thus the machine 1) comprises:
a winding core 6 rotatable about an axis of rotation, configured to grip the strips 3, 4 and operable in rotation to drag the gripped strips 3, 4 to form a winding 2; and
a feeding unit 7 configured to feed strips 3, 4 to the winding core 6 along respective separate feeding paths P.

In the case illustrated, each formed winding 2 is a cylindrical winding with a longitudinal central axis A, a longitudinal lateral surface 2a and two axial surfaces 2b of opposing ends.

Preferably, the feeding unit 7 includes a plurality of support shafts or spindles each adapted to support a respective strip coil 3 or 4 in a rotatable manner.

The winding core 6 comprises a so-called “spindle” (known per se and not illustrated), which generally consists of a bar formed by two elongated elements rotatable about the axis of rotation and movable along a direction parallel to the axis of rotation between an opening configuration, in which the elements are offset from each other, and a gripping configuration, in which the elements are at least partially facing each other to hold the strips 3, 4 gripped together, so as to be able to drag them in rotation and determine the progressive formation of the winding 2 around the axis of rotation.

In use, each strip 3, 4 is unwound from its respective coil along the respective feeding path P to the winding core 6.

The latter, once the strips 3, 4 have been grasped, is operated in rotation about its own axis, causing the strips 3, 4 themselves to be dragged or pulled (unwound) from the coils of the feeding unit 7.

Conveniently, the feeding unit 7 feeds, in use, a first electrode strip 3 (e.g. the cathode) at a position interposed between the two separator strips 4.

In more detail, the feeding path P of the cathode 3 lies between the feeding paths P of the separators 4.

Conveniently, the feeding path P of the other electrode strip 3 (e.g. the anode) is positioned in such a way that the anode strip 3 itself is superimposed on the separator strip 4 radially inwards with respect to the winding 2.

In this way, the cathode strip 3 is fed to the winding core 6 already interposed between the two initially spaced separator strips 4, so as to obtain the aforementioned alternating electrode-separator-electrode-separator pattern (in detail, anode-separator-cathode-separator).

The strips 3, 4, i.e. the P feeding paths, all converge at the winding core 6.

The above is illustrated in FIG. 1.

Conveniently, the apparatus 1 also comprises guiding members 8, grippers 10 and cutting devices 11 whose operation is known, for example from patent application No. IT102021000021314, in the name of the Applicant itself and shall thus not be described in detail. Briefly: the guide members 8 are each configured to grasp a respective electrode strip 3 and advance it towards the core 6 at the feed rate thereof, so as to avoid unwanted stretching or tensioning at the beginning of each winding; the grippers 10 are designed to grasp the respective strips 3, 4 to facilitate cutting them; and the cutting devices 11 are configured to cut the strips to a certain length, once the desired size of the winding 2 has been reached.

The operation of the guide members 8, grippers 10 and cutting devices 11 is described in the above-mentioned patent application No. IT102021000021314.

As shown in FIG. 1, the apparatus 5 comprises a winding station B defining a final convergence end of the feeding paths P and at which a winding 2 is formed cyclically by rotational operation of the winding core 6.

The apparatus 5 further comprises:
a closing device (known per se and not illustrated nor described in detail) configured to close with a layer of adhesive material, in a known manner, the winding 2 formed during a “taping” process and arranged at a closing (or “taping”) station C positioned operationally downstream of the winding station B;
an unloading unit (known per se and not illustrated nor described in detail) of the formed and closed winding 2 arranged at an unloading station D positioned operationally downstream of the closing station C.

In accordance with what has just been described, the core 6 is movable between the winding station B, where it receives the strips 3, 4 and winds them as explained above to form one winding 2 at a time, the closing station C, where said winding 2 is closed by the closing device, and the unloading station D, where the unloading unit unloads the formed and closed winding 2.

For this purpose, the apparatus 5 comprises a movement device, in particular a rotating platform, even more particularly a star wheel 12 rotatable about an axis of rotation, preferably parallel to the axis of rotation of the core 6, and configured to sequentially move the core 6 between the winding station B, the taping station C, the unloading station D and again the winding station B.

Conveniently, the apparatus 5 comprises a plurality of winding cores 6, in particular three cores 6 carried by the wheel 12 and equally spaced around the axis of rotation of the latter so as each to occupy one of the three stations B, C or D.

According to the invention, the machine 1 further comprises an applicator apparatus 14 operatively arranged downstream of the winding core 6, i.e., downstream of the apparatus 5, in particular downstream of (or at) the unloading station D, and configured to apply an electrically insulating tape 15 to each previously formed (and unloaded) winding 2.

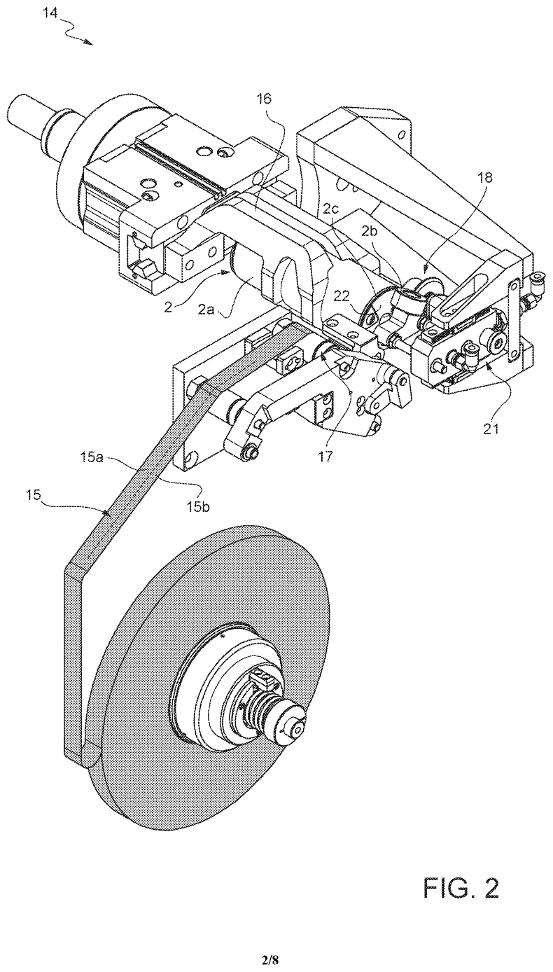

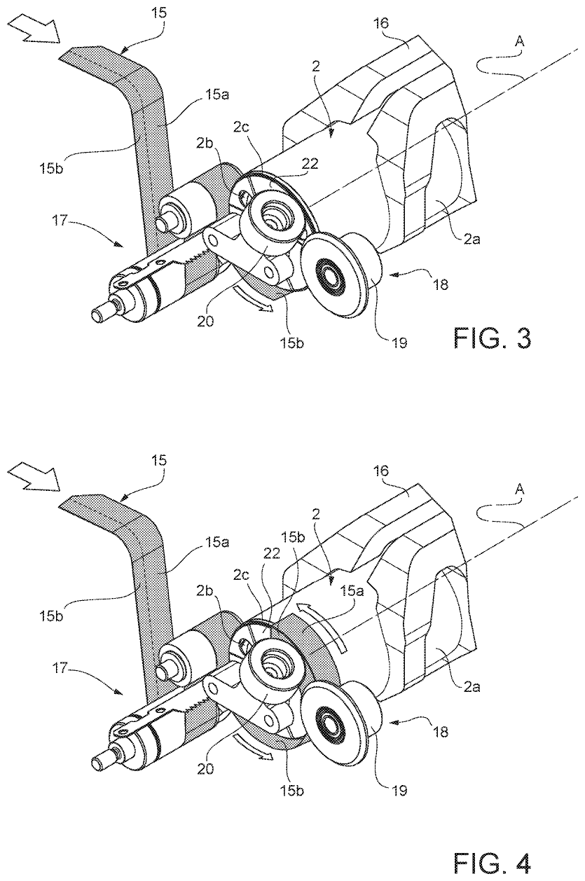

As can be seen in FIG. 2, the apparatus 14 includes:
a retaining member, preferably a mandrel 16, configured to hold the winding 2 and operate it in rotation about the longitudinal axis A thereof;
a feeding device 17 configured to feed the insulating tape 15 to the winding 2 being gripped, in use, on the mandrel 16 and to progressively fasten, by rotational operation of the winding 2, a first longitudinal portion 15a of the insulating tape 15 to an axial end edge 2c of the longitudinal lateral surface 2a of the winding 2, such that a second longitudinal portion 15b of the insulating tape 15, adjacent to the first longitudinal portion 15a, protrudes axially from the end edge 2c (FIG. 3) ; and
a folding device 18 operatively arranged downstream of the feeding device 17 and configured to progressively fold the second longitudinal portion 15b of the insulating tape 15 towards, in particular onto, the axial surface 2b of the winding 2 adjacent to the aforementioned end edge 2c (FIG. 4).

Preferably, the insulating tape 15 is self-adhesive.

Preferably, the insulating tape 15 is made of plastic material.

Preferably, the insulating tape 15 is not heat-shrinkable.

In other words, the end portion of each previously formed winding 2, defined by the edge 2c and the radially outermost portion of the axial surface 2b adjacent to the edge 2c, is electrically insulated by applying a predetermined length of insulating tape 15.

In detail, as can be seen in FIG. 3, the insulating tape 15 is first progressively fastened, by means of rotational operation of the winding 2, to the edge 2c by fixing the first longitudinal portion 15a and with the second longitudinal portion 15b protruding axially from the edge 2c. Then, as can be seen in FIG. 4, the second longitudinal portion 15b is progressively folded onto the axial surface 2b, by means of the folding device and the above-mentioned rotational operation.

With this configuration, better electrical insulation of winding 2 from the can (in particular of the negative terminal from the positive terminal, i.e. from the metal lateral surface) is achieved than with the above-mentioned known systems and methods (adhesive labels, discs, or caps). In fact, better insulation of the aforementioned end portion is ensured, while simplifying the process of applying the insulation element, making it more suitable for high production speeds and more precise than known methods.

According to some preferred embodiments, the folding device 18 comprises a folding member 19 adapted to be positioned, in use, near said edge 2c and configured to progressively fold the second longitudinal portion 15b towards the axial surface 2b.

According to other, non-limiting and non-illustrated embodiment, the folding device 18 comprises blowing members, which, in use, progressively fold the second longitudinal portion 15b towards the axial surface 2b.

Advantageously, but not restrictively, the folding device 18 also comprises a pressing member 20 operatively arranged downstream of the folding member 19, adapted to be positioned, in use, in proximity to the edge 2c, and configured to press the second longitudinal portion 15b against the axial surface 2b adjacent to the edge 2c, corresponding to one of the two front faces, or bases, of the winding 2.

In other words, the fold of insulating tape 15 effectively electrically insulates the winding 2 from the metal container (known as the “can”) that usually houses it.

According to this embodiment, the folding member comprises, in particular is defined by, a folding roller 19 adapted to be arranged adjacent to the edge 2c, and the pressing member comprises, in particular is defined by, a presser roller 20 suitable to be arranged adjacent to the edge 2c, in a position facing the axial surface 2b.

This peculiar configuration ensures complete folding of the insulating tape 15 and, therefore, correct application thereof on the winding 2. As a result, the risk of damage to the insulating tape 15 during the “canning” operation (i.e. inserting the winding 2 into the respective can) is reduced, and the risk of short circuits is also limited.

In addition, the insulating tape 15 also acts as a protective element for the edge 2c of the winding 2 during canning.

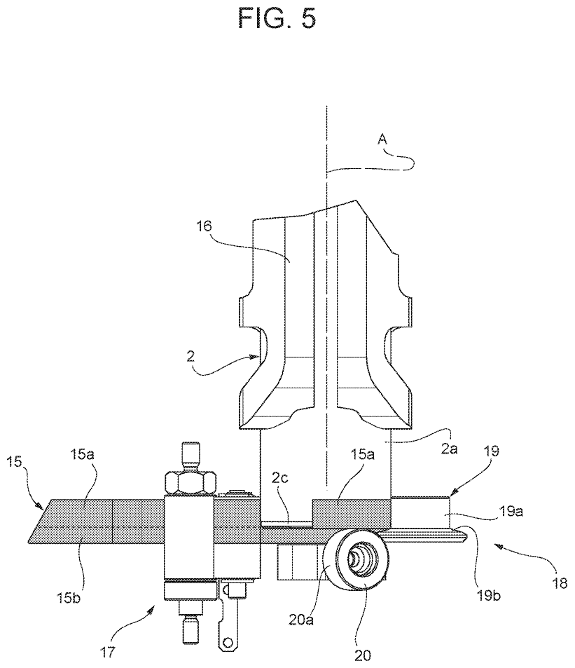

As can be seen in FIG. 5, the folding roller 19 has, advantageously:
a first cylindrical lateral surface 19a to press the first longitudinal portion 15a against the longitudinal lateral surface 2a of the winding 2 at the edge 2c; and
a second truncated conical lateral surface 19b to progressively fold the second longitudinal portion 15b towards the axial surface 2b of the winding 2.

Conveniently, the folding roller 19 is arranged with its axis of rotation parallel to the longitudinal axis A of the winding 2 in use on the mandrel 16.

The configuration described above allows effective folding of the second longitudinal portion 15b by means of a very simple and relatively uncomplicated system.

As can be seen in FIG. 5, the presser roller 20 is arranged with its axis of rotation transverse to the longitudinal axis A of the winding 2 in use on the spindle 16. The presser roller 20 has a cylindrical lateral surface 20a adapted to cooperate with the second longitudinal portion 15b to progressively press it onto the axial surface 2b.

In particular, the lateral surface 20a is adapted to face the axial surface 2b.

Thus, the second longitudinal portion 15b is effectively pressed onto the axial surface 2b in a simple and relatively uncomplicated manner.

Advantageously, the machine 1 comprises a movement and damping system 21 configured for:
moving the folding member 19 and the pressing member 20, independently of each other, to and from the edge 2c of the winding 2 in use at the mandrel 16; and for
supporting the folding member 19 and the pressing member 20 independently of each other.

This system 21 is partially illustrated in FIG. 2.

Thanks to the system 21, the applicator apparatus 14 is able to adapt to different sizes of windings 2 to be electrically insulated. Furthermore, the applicator apparatus 14 is able to compensate for any eccentricities and/or surface imperfections of the windings 2 to be electrically insulated.

Preferably, the movement and damping system 21 is of the pneumatic type.

This makes it particularly easy to apply different pressures to the folding member 19 and the pressing member 20, further increasing the adaptability of the apparatus 14.

Alternatively, the 21 system could be of the hydraulic, hydraulic, electric or spring type or a combination of these.

Advantageously, the first longitudinal portion 15a has a transverse extension, with respect to the longitudinal direction of the insulating tape 15, greater than the transverse extension of the second longitudinal portion 15b.

In other words, more than the transverse half of the insulating tape 15 is fastened, in use by means of the feeding device 17 and by the operational rotation of the winding 2 by the mandrel 16, on the longitudinal lateral surface 2a of the winding 2 at the edge 2c.

The Applicant has observed that this helps reduce the risk of wrinkles forming in the second longitudinal portion 15b when it is folded, resulting in a more uniform and homogeneous fold, especially in the case of small windings 2 (e.g. small diameter). In addition, this prevents excessive axial thickening of the winding 2, which could compromise correct insertion in the respective can.

According to this preferred embodiment, the machine 1 comprises a unit (not illustrated) operatively arranged downstream of the winding core 6 (e. g. downstream of the unloading station D) and upstream of the applicator apparatus 14 and configured to fasten, in particular for soldering, an electrical contact element 22 on the axial surface 2b of the winding. Thus, the axial surface 2b of the winding becomes the electrical contact 22 itself.

In the case illustrated, this electrical contact element is defined by a disc 22 made of an electrically conductive material, e.g. metal. The disc 22 serves as the connection element to the relevant terminal (of the storage device) for one of the two electrode strips 3.

Preferably, therefore, in this non-limiting case, the winding 2 comprises the electrical contact disc 22, which itself defines the axial surface 2b onto which the insulating tape 15 is folded.

In this case, therefore, the folding device 18 is configured to progressively fold the second longitudinal portion 15b onto the electrical contact disc 22 fastened to the winding 2 and which determines the axial surface 2b.

The machine 1 according to the invention therefore allows the use of this advantageous configuration, which, as specified above, allows the use of “tabless” electrode strips 3. In fact, it would be particularly difficult, if not impossible, to use a disc 22 with conventional electrical insulation methods and systems, which do not involve the application of an insulating tape 15 as described in accordance with the present invention.

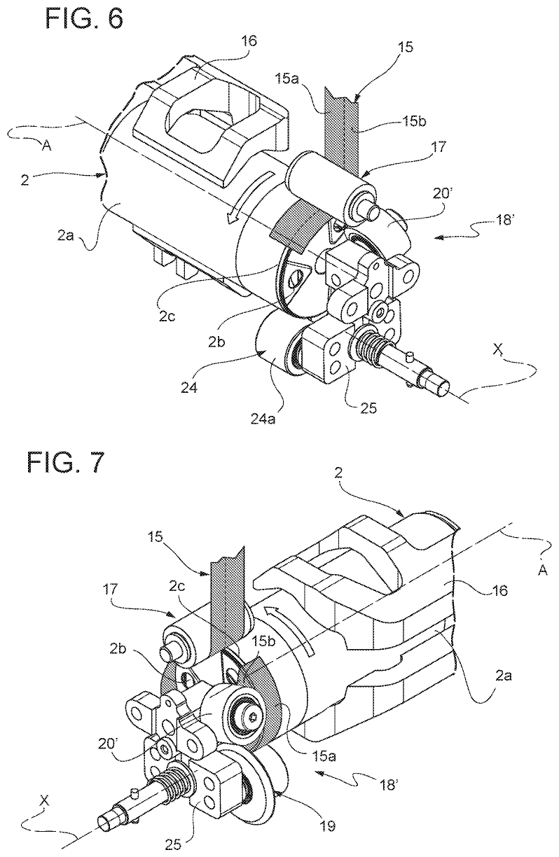

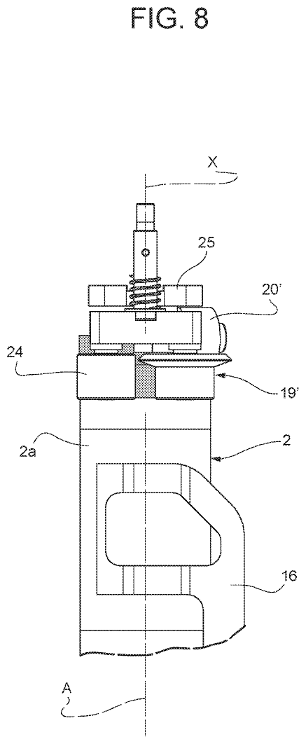

With reference to FIGS. 6, 7 and 8, an alternative embodiment of the present invention will be described below, where the same reference numbers have been maintained to indicate similar or corresponding parts.

In particular, this embodiment differs from the one described above and illustrated in FIGS. 2 to 5, in that the applicator apparatus 14 comprises, instead of the folding device 18, a folding device 18′ in which:
the folding member comprises, in particular is defined by, a folding roller 19′, very similar to the folding roller 19;
the pressing member comprises, in particular is defined by, a presser roller 20′ which is designed to be arranged adjacent to the edge 2c, in a position facing the axial surface 2b, and is therefore entirely similar to the presser roller 20; and
a further pressing member 24 operatively arranged upstream of the folding roller 19′, adapted to be positioned, in use, in proximity to the edge 2c, and configured to press the first longitudinal portion 15a against the longitudinal lateral surface 2a of the winding 2 at the edge 2c itself.

In detail, the further pressing member comprises a further presser roller 24 which is arranged adjacent to the edge 2c, in a position facing the longitudinal lateral surface 2a.

In more detail, the additional presser roller 24 is designed to be arranged with its axis of rotation parallel to the longitudinal axis A of the winding 2 in use on the mandrel 16. The additional presser roller 24 has a cylindrical lateral surface 24a adapted to cooperate with the first longitudinal portion 15a to progressively press it onto the lateral surface 2a.

In particular, the lateral surface 24a is adapted to face the lateral surface 2a.

In this way, the first longitudinal portion 15a is effectively pressed onto the lateral surface 2a operatively prior to the folding of the second longitudinal portion 15b, in a simple and relatively uncomplicated manner.

The Applicant has observed that the presence of the additional presser roller 24 upstream of the folding roller 19′ ensures complete pressing of the first longitudinal portion 15a on the lateral surface 2a, thus reducing the risk of wrinkles forming within the strip 15 after the strip has been cut at the end of the application, which could compromise the “canning” operation, i.e. the insertion of the winding 2 into the relative can.

The folding device 18′ also comprises a pivoting element 25 pivotally mounted to the applicator apparatus 14 to pivot about a central axis X. Advantageously, the folding roller 19′ and the further presser roller 24 are coupled to the pivoting element 25 to pivot about the central axis X integrally with each other.

In the case illustrated, the pivoting element is defined by a bracket 25 configured to oscillate around the axis X and carrying the folding roller 19′ and the further presser roller 24.

Thanks to this configuration, the folding device 18′ is more adaptable to the various winding 2 formats and, above all, is able to “absorb” the tolerance inaccuracies of the various windings 2 to be processed, which may have small surface irregularities compared to the nominal diameter.

In this case, the tangency of the folding roller 19′ and the additional presser roller 24 to the winding 2 is maintained by the pivoting bracket 25.

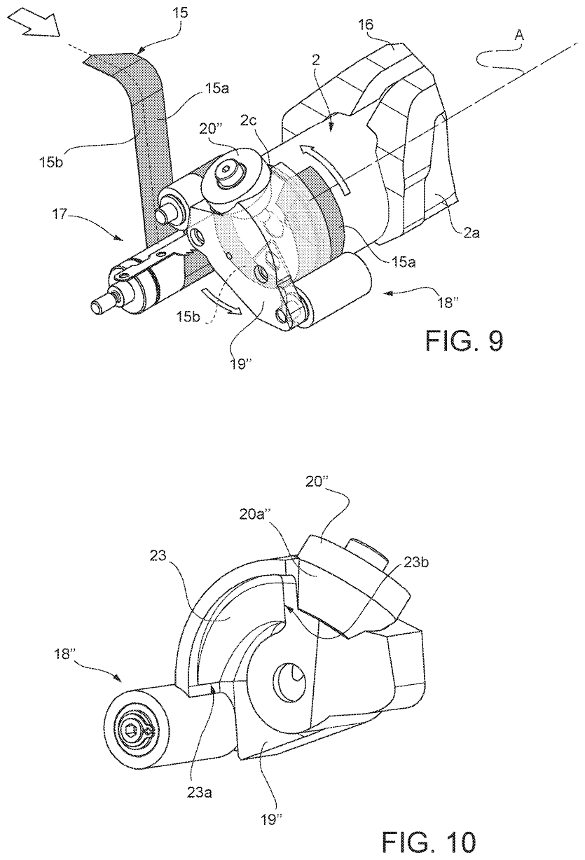

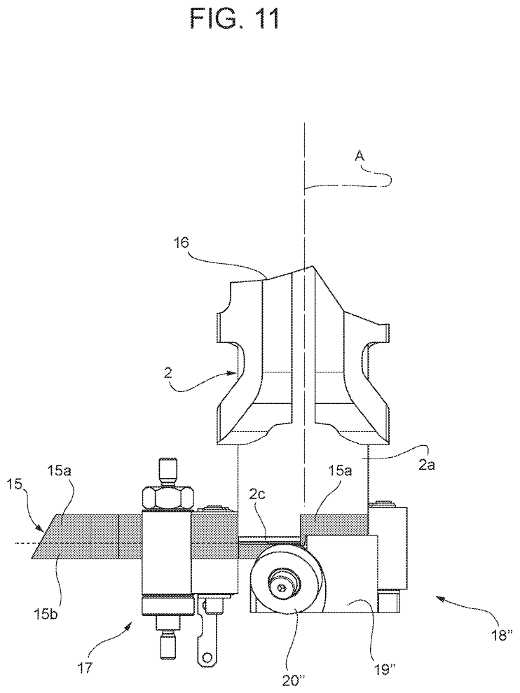

With reference to FIGS. 9, 10 and 11, an alternative embodiment not forming part of the present invention and shown for illustrative purposes only will be described below, where the same reference numbers have been maintained to indicate similar or corresponding parts.

In particular, this embodiment differs from those described above and illustrated in FIGS. 2 to 8, in that the applicator apparatus 14 comprises, instead of the folding device 18, 18′ a folding device 18′′ in which:
the folding member comprises, and in particular is defined by, a folding element 19′′ adapted to be arranged adjacent to the edge 2c and defining a channel or track 23 adapted to slidably support the insulating tape 15 fed by the feeding device 17 to fold it; and
the pressing member comprises, in particular is defined by, a presser roller 20′′ that is positioned adjacent to the edge 2c, facing the axial surface 2b.

More precisely, as is particularly visible in FIG. 7, the channel or track 23 has a conformation which is warped in such a way as to impart to the second longitudinal portion 15b (which slides, in use, on it as a result of the rotational operation of the winding 2 by the spindle 16) an angular movement from an initial position to a folded position towards the axial surface 2b.

In more detail, the channel 23 has:
an inlet section 23a at which the wall defining the channel has an orientation substantially parallel, in use, to the longitudinal lateral surface 2a (at the edge 2c), and thus substantially parallel to the insulating tape 15; and
an outlet section 23b at which the wall defining the channel has an orientation substantially parallel, in use, to the axial surface 2b.

The wall of the channel 23 that joins the inlet section 23a to the outlet section 23b therefore has a curved and warped conformation defining a smooth and progressive transition from the orientation of section 23a to the orientation of section 23b.

Therefore, the second longitudinal portion 15b running on the channel 23 will be progressively bent from the first to the second orientation and, therefore, towards the axial surface 2b.

The Applicant has noted that this configuration is particularly effective for folding the insulating tape 15 onto the axial surface 2b. In addition, wear is limited, compared to the folding roller 19, 19′ and therefore the service life of the components is increased.

Conveniently, the presser roller 20″ has a lateral surface 20a″ adapted to cooperate with the second longitudinal portion 15b to progressively press it onto the axial surface 2b and has a truncated cone shape.

This configuration is particularly advantageous in that the peripheral linear velocity at the surface 20a″ is constant irrespective of the diameter of the winding 2. The adaptability of the applicator apparatus 14 is thus further increased.

In some non-limiting and non-illustrated cases, the described embodiments are combined, using a presser roller 20″ in combination with a folding roller 19, 19″ or a presser roller 20, 20′ in combination with a folding member 19″.

Advantageously but not restrictively, in order to avoid interruptions in production, the feeding device 17 includes a splicing device or “splicer” (known per se and not described in detail or illustrated) configured to automatically join together the end flap of a depleted coil of insulating tape 15 with the starting flap of a full coil.

From the foregoing, it is clear that machine 1 enables the implementation of a method for the production of windings starting from at least one strip of material suitable for the manufacture of electrical energy storage devices, the method comprising the steps of:
a) feeding the strip along a feeding path from a feeding unit to a winding core rotatable around an axis of rotation;
b) gripping the strip by means of the winding core;
c) operating in rotation the winding core;
d) winding, by means of step c) of rotational operation, the gripped strip around the axis of rotation, so as to form a winding with a central longitudinal axis, a longitudinal lateral surface and two opposing axial end surfaces; wherein the method further comprises the steps of:
e) retaining the previously formed winding;
f) feeding an electrically insulating tape to the retained winding;
g) operating in rotation the retained winding around the longitudinal axis thereof;
h) fastening, by means of the step of feeding and operating in rotation, a first longitudinal portion, of the insulating tape to an axial end edge of the longitudinal lateral surface of the winding, so that a second longitudinal portion of the insulating tape, adjacent to the first longitudinal portion, protrudes axially from said end edge; and
i) progressively folding the second longitudinal portion onto the axial surface of the winding adjacent to said end edge.

In particular, the folding step i) comprises the steps of:
l) folding the second longitudinal portion towards said axial surface;
m) pressing said second longitudinal portion against said axial surface.

More specifically, the folding step l) comprises:
operating in rotation a folding roller; or
running the insulating tape along a channel or folding track having a warped conformation so as to impart to said second longitudinal portion an angular movement from an initial position to a folded position towards said axial surface;
and wherein the pressing step m) comprises operating in rotation a presser roller.

Conveniently, the fastening step h) comprises winding the insulating tape onto said end edge for at least one revolution about said longitudinal axis, so as to completely cover said end edge.

This configuration is particularly advantageous in that it allows complete isolation of the winding 2 from the can in which it will be inserted.

Alternatively, the fastening step h) could comprise partially winding the insulating tape around said end edge, so as to leave at least a portion of said end edge uncovered.

This configuration is particularly advantageous if the electrode strips are provided with the aforesaid tabs, as the uncovered (angular) portion of the end edge allows the tab of the respective electrode strip to be accommodated.

According to a further aspect of the present invention, a storage device is provided comprising a winding 2 and a hollow container housing the winding 2, i.e. a “can”, preferably metallic.

In particular, the storage device further comprises electrically insulating tape 15 applied to an axial end of the winding 2, wherein the first longitudinal portion 15a of the insulating tape 15 is fastened to the longitudinal lateral surface 2a at an axial end edge 2c of the longitudinal lateral surface 2a itself; and wherein the second longitudinal portion 15b of the insulating tape 15, adjacent to the first longitudinal portion 15a, is folded against the axial surface 2b of the winding adjacent to the end edge 2c, corresponding to one of the two front faces, or bases, of the winding 2. In other words, the fold of insulating tape 15 effectively electrically insulates the winding 2 from the metal container that houses it.

Preferably, the insulating tape 15 is at least partially (in particular, totally) interposed between the winding 2 and the metal container that houses it.

As previously mentioned, preferably, the first longitudinal portion 15a has a transverse extension, with respect to the longitudinal direction of the insulating tape 15, greater than the transverse extension of the second longitudinal portion 15b, such that more than half of the transverse half of the insulating tape 15 is fastened onto said longitudinal lateral surface 2a of the winding 2 at the end edge 2c.

Additionally, advantageously but not necessarily, the storage device comprises the electrical contact element 22 on said axial surface 2b of the winding 2, onto which the second longitudinal portion 15b is folded.

From an examination of the characteristics of the machine 1 and the related method according to the present invention, the advantages it allows to be obtained are evident.

In particular, due to the peculiar configuration of the applicator apparatus 14, the electrical insulation of the winding 2 from the can containing it is improved, while simplifying the application of the insulating element compared to the above-mentioned known methods and systems.

For the advantages of the particular embodiments, reference is to be made to the above.

It is clear that modifications and variations can be made to the machine 1 and to the related method described and shown herein without thereby departing from the scope of protection defined by the claims.

In particular, the presser roller 20 of the folding device 18 could comprise a truncated conical surface 20a.

1. Automatic machine (1) for the production of windings (2) starting from at least one strip (3, 4) of material suitable for the manufacture of electrical energy storage devices, the machine (1) comprising:
an applicator apparatus (14) configured to apply an electrically insulating tape (15) to a previously formed winding (2);
the applicator apparatus (14) comprising:
a retaining member (16), preferably a spindle, for holding the winding (2) and for actuating it in rotation about a longitudinal axis (A) thereof;
a feeding device (17) configured to feed the insulating tape (15) towards the gripped winding (2), in use, on the retaining member (16) and to fasten progressively, by actuation in rotation of the winding (2), a first longitudinal portion (15a) of the insulating tape (15) to an axial end edge (2c) of the longitudinal lateral surface (2a) of the winding (2), so that a second longitudinal portion (15b) of the insulating tape (15), adjacent to the first longitudinal portion (15a), protrudes axially from said end edge (2c); and
a folding device (18, 18′) operatively arranged downstream of the feeding device (17) and configured to progressively refold the second longitudinal portion (15b) of the insulating tape (15) onto the axial surface (2b) of the winding (2) adjacent to said end edge (2c).

2. Automatic machine (1) as claimed in claim 1, wherein the folding device (18, 18′) comprises:
a folding member (19, 19′) configured to be positioned, in use, in proximity to said end edge (2c) and configured for progressively folding said second longitudinal portion (15b) towards said axial surface (2b); and
a pressing member (20, 20′) operatively arranged downstream of the folding member (19, 19′), configured to be positioned, in use, in proximity to said end edge (2c), and configured for pressing said second longitudinal portion (15b) against said axial surface (2b) adjacent to the end edge (2c).

3. Automatic machine (1) as claimed in claim 2, wherein the folding member comprises a folding roller (19, 19′) configured to be arranged adjacent to said end edge (2c),
and wherein the pressing member comprises a presser roller (20, 20′) configured to be arranged adjacent to said end edge (2c), in a position facing said axial surface (2b).

4. Automatic machine (1) as claimed in claim 3, wherein the folding roller (19, 19′) has:
a first cylindrical lateral surface (19a) for pressing said first longitudinal portion (15a) against said longitudinal lateral surface (2a) of the winding (2) at said end edge (2c); and
a second frustum-conical lateral surface (19b) for progressively bending said second longitudinal portion (15b) towards said axial surface (2b) of the winding (2).

5. Automatic machine (1) as claimed in claim 2, wherein the folding device (18′) further comprises a further pressing member (24) operatively arranged upstream of the folding member (19′), adapted to be positioned, in use, in proximity to said end edge (2c), and configured to press said first longitudinal portion (15a) against said longitudinal lateral surface (2a) of the winding (2) at said end edge (2c).

6. Automatic machine (1) as claimed in claim 3, wherein the further pressing member comprises a further presser roller (24) adapted to be arranged adjacent to said end edge (2c), in a position facing said longitudinal lateral surface (2a).

7. Automatic machine (1) as claimed in claim 6, wherein the folding device (18′) comprises a pivoting element (25) rotatably mounted to the applicator apparatus (14) for pivoting around a central axis (X), and wherein the folding roller (19′) and the further presser roller (24) are coupled to the pivoting element (25) to pivot about said central axis (X) integrally with one other.

8. Automatic machine (1) as claimed in claim 3, wherein the presser roller (20, 20′) is adapted to be arranged with its axis of rotation transverse to the longitudinal axis (A) of the gripped winding (2), in use, on the retaining member (16), the presser roller (20, 20′) having a cylindrical lateral surface (20a) adapted to cooperate with the second longitudinal portion (15b) for pressing it progressively onto the axial surface (2b) of the winding (2).

9. Automatic machine (1) as claimed in claim 2, to 8, and comprising a movement and damping system (21) configured to move the folding member (19, 19′) and the pressing member (20, 20′), independently from one another, towards and away from the end edge (2c) of the gripped winding (2), in use, on the retaining member (16), and to support in a damped manner the folding member (19, 19′) and the pressing member (20, 20′) independently from one another.

10. Automatic machine (1) as claimed in claim 9, wherein the movement and damping system (21) is of the pneumatic type.

11. Automatic machine (1) as claimed in claim 1, wherein said first longitudinal portion (15a) has a transverse extension, with respect to the longitudinal direction of the insulating tape (15), greater than the transverse extension of the second longitudinal portion (15b), so that more than the transverse half of the insulating tape (15) is fastened, by means of the feeding device (17) and by means of the actuation in rotation of the winding (2) by the retaining member (16), on said longitudinal lateral surface (2a) of the winding (2) at said end edge (2c).

12. Automatic machine (1) as claimed in claim 1, and comprising a unit operatively arranged downstream of the winding core (6) and upstream of said applicator apparatus (14) and configured for fastening an electrical contact element (22) on said axial surface (2b) of the winding (2);
and wherein the folding device (18, 18′) is configured to progressively refold the second longitudinal portion (15b) onto the electrical contact element (21) fastened onto said axial surface (2b).

13. Automatic machine (1) as claimed in claim 1, and comprising:
a winding core (6) rotatable around a rotation axis, configured to grip said strip (3, 4) of material and operable in rotation for dragging the gripped strip (3, 4) and thereby forming a winding (2) having a longitudinal central axis (A), a longitudinal lateral surface (2a) and two axial end surfaces (2b) opposite to one another;
a feeding unit (7) for feeding the strip (3, 4) of material to the winding core (6) along a respective feeding path (P);
wherein the applicator apparatus (14) is arranged operatively downstream of the winding core (6).

14. Method for the production of windings (2) starting from at least one strip (3, 4) of material suitable for the manufacture of electrical energy storage devices, the method comprising the steps of:
retaining a previously formed winding (2) having a central longitudinal axis (A), a longitudinal lateral surface (2a) and two axial end surfaces (2b) opposite to one another;
feeding an electrically insulating tape (15) towards the retained winding (2);
actuating in rotation the retained winding (2) about the longitudinal axis (A) thereof;
progressively fastening, by means of the step of feeding and actuating in rotation, a first longitudinal portion (15a) of the insulating tape (15) to an axial end edge (2c) of the longitudinal lateral surface (2a) of the winding (2), so that a second longitudinal portion (15b) of the insulating tape (15), adjacent to the first longitudinal portion (15a), projects axially from said end edge (2c); and
progressively refolding the second longitudinal portion (15b) onto the axial surface (2b) of the winding (2) adjacent to said end edge (2c).

15. Method as claimed in claim 14, and comprising the further and preceding steps of:
feeding the strip (3, 4) along a feeding path (P) from a feeding unit (7) to a winding core (6) rotatable about an axis of rotation;
gripping the strip (3, 4) by means of the winding core (6);
operating in rotation the winding core (6);
winding, by means of the step of actuating in rotation, the gripped strip (3, 4) about the axis of rotation, so as to form a winding (2).

16. Method as claimed in claim 14, wherein the refolding step comprises the steps of:
folding the second longitudinal portion (15b) towards said axial surface (2b);
pressing said second longitudinal portion (15b) against said axial surface (2b).

17. Method as claimed in claim 16, wherein the folding step comprises:
actuating in rotation a folding roller (19, 19′);
and wherein the pressing step comprises actuating in rotation a presser roller (20, 20′).

18. Method as claimed in claim 14, wherein:
the fastening step comprises winding the insulating tape (15) onto said end edge (2c) for at least one turn about said longitudinal axis (A), so as to completely cover said end edge (2c); or
the fastening step comprises partially winding the insulating tape (15) onto said end edge (2c), so as to leave at least a portion of said end edge (2c) uncovered.

19. Method as claimed in claim 14, and comprising the step of:
fastening an electrical contact element (22) onto said axial surface (2b) of the winding (2) prior to the fastening step;
and wherein the refolding step comprises progressively refolding the second longitudinal portion (15b) of the insulating tape (15) onto the electrical contact element (22) fastened onto said axial surface (2b).

20. Electrical energy storage device comprising:
a winding (2) formed starting from at least one strip (3, 4) of material suitable for the manufacture of electrical energy storage devices; and
a hollow container housing the winding (2);
the winding (2) having a longitudinal central axis (A), a longitudinal lateral surface (2a) and two opposite axial surfaces (2b);
wherein the storage device further comprises an electrically insulating tape (15) applied to an axial end of the winding (2),
wherein a first longitudinal portion (15a) of the insulating tape (15) is fastened to the longitudinal lateral surface (2a) at an axial end edge (2c) of the longitudinal lateral surface (2a) itself;
wherein a second longitudinal portion (15b) of the insulating tape (15), adjacent to the first longitudinal portion (15a), is refolded against the axial surface (2b) of the winding (2) adjacent to said end edge (2c).

21. Device according to claim 20, wherein said first longitudinal portion (15a) has a transverse extension, with respect to the longitudinal direction of the insulating tape (15), greater than the transverse extension of the second longitudinal portion (15b), so that more than the transverse half of the insulating tape (15) is fastened onto said longitudinal lateral surface (2a) of the winding (2) at said end edge (2c).

22. Device according to claim 20, and comprising an electrical contact element (22) on said axial surface (2b) of the winding (2), wherein the second longitudinal portion (15b) is refolded onto the electrical contact element (21) fastened onto said axial surface (2b).
